(19) United States
(12) Patent Application Publication
(10) Pub. No.: US 2008/0168144 A1
(43) Pub. Date: Jul. 10, 2008

(54) Method of, and a System for, Processing Emails

(76) Inventor: Martin Giles Lee, Oxford (GB)

Correspondence Address: NIXON & VANDERHYE, PC, 901 NORTH GLEBE ROAD, 11TH FLOOR, ARLINGTON, VA, 22203, US

(21) Appl. No.: 11/884,939

(22) PCT Filed: Apr. 4, 2006
(86) PCT No.: PCT/GB2006/001229

§ 371 Date: Aug. 23, 2007

(30) Foreign Application Priority Data
Apr. 4, 2005 (GB) 0506844.0

(51) Int. Cl. G06F 15/16

(52) U.S. Cl. 709/206

(57) ABSTRACT

A system for identifying unknown email as spam. An extractor extracts components of email which contains pseudo-random data. This data is passed to the pattern generator which identifies the pattern descriptions found within the data. Pattern descriptions which are found to match components in a store of components from previously encountered spam emails and not in a store from previously encountered non-spam emails by the pattern generator are passed to the pattern matcher. The pattern matcher examines components of unknown email extracted by the extractor. If any component from an unknown email is found to match a pattern description known to the pattern matcher, the email is identified as spam and a signal sent to the spam output, otherwise the email is identified as non-spam and a signal sent to the non-spam output.

The present invention relates to a method of, and system for, processing emails, in particular classifying spam emails and non-spam emails. Spam email (in other words, bulk unsolicited email) causes increasing nuisance by flooding recipients' email inboxes with unwanted messages. Frequently the contents of the spam may contain fraudulent or explicit content and may cause distress or financial loss. The time spent dealing with these messages, the resources required to store and process them on an email system, and wasted network resources can be a significant waste of money. Numerous measures have been proposed to detect spam. However spammers have reacted to disguise their emails in an attempt to thwart spam detection measures.

This present invention is based upon an appreciation of the fact that software used to send email includes apparently random data within the email which is characteristic of the software. Examination of this pseudo-random data allows the generation of descriptive patterns which can be used to identify emails sent using software used by spammers.

According to a first aspect of the present invention, there is provided a automated method of processing emails comprising:

a) defining a pattern description of a string of characters of an email, the pattern description comprising a collection of pattern matching expressions each selected from a set of such expressions which are capable of specifying with differing degrees of specificity a match with a character or with a collection of characters;

b) testing the pattern description against training sets of strings of characters extracted from emails belonging to a set of spam emails and a set of non-spam emails to determine the effectiveness of the pattern description as a classifier of individual ones of those emails into the respective sets of spam emails and non-spam emails; and

c) storing, as a reference pattern description, a pattern description determined by step b) as an effective classifier; and

d) classifying each email to be processed, using at least one reference pattern description stored in step c), into one of the respective sets of spam email and non-spam email.

According to a second aspect of the present invention, there is provided an automated system for processing emails comprising:

a) means for defining a pattern description of a string of characters of an email, the pattern description comprising a collection of pattern matching expressions each selected from a set of such expressions which are capable of specifying with differing degrees of specificity a match with a character or with a collection of characters;

b) means for testing the pattern description against training sets of strings of characters extracted from emails belonging to a set of spam emails and a set of non-spam emails to determine the effectiveness of the pattern description as a classifier of individual ones of those emails into the respective sets of spam emails and non-spam emails; and

c) means for storing, as a reference pattern description, a pattern description determined by the means b) as an effective classifier;

d) means for classifying each email to be processed, using at least one reference pattern description stored in means c), into one of the respective sets of spam emails and non-spam emails.

Thus the invention provides for classification of emails as being spam emails or non-spam emails. It provides effective classification by use of pattern description comprising a collection of pattern matching expressions each selected from a set of such expressions which are capable of specifying with differing degrees of specificity a match with a character or with a collection of characters. Such a type of pattern description is particularly effective at recognising pseudo-random data within the email which is characteristic of spam. This because such pseudo-random data is generated by the spammer in a manner that it tends not to be entirely random and has structure which can be recognised by the pattern description of the present invention.

The strings of characters considered are conveniently derived from the components of emails which tend to contain such pseudo-random data of the type described above, for example a message-ID, a MIME-Boundary or a URL.

The invention will be further described by way of non-limiting example with reference to the accompanying drawings in which:

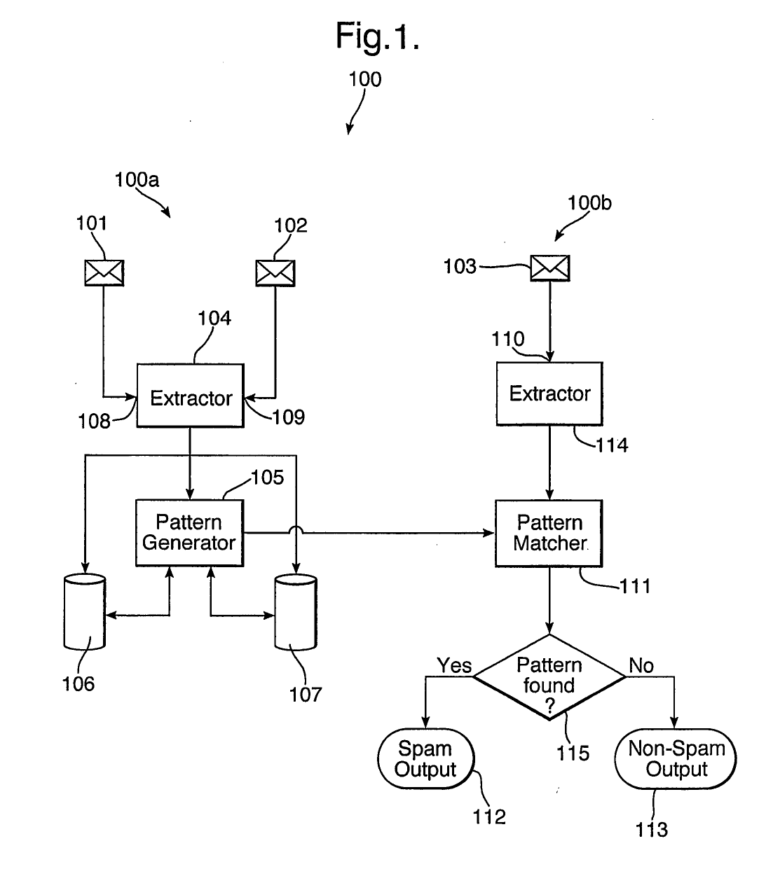

FIG. 1 is a block diagram of one embodiment of a system according to the present invention; and

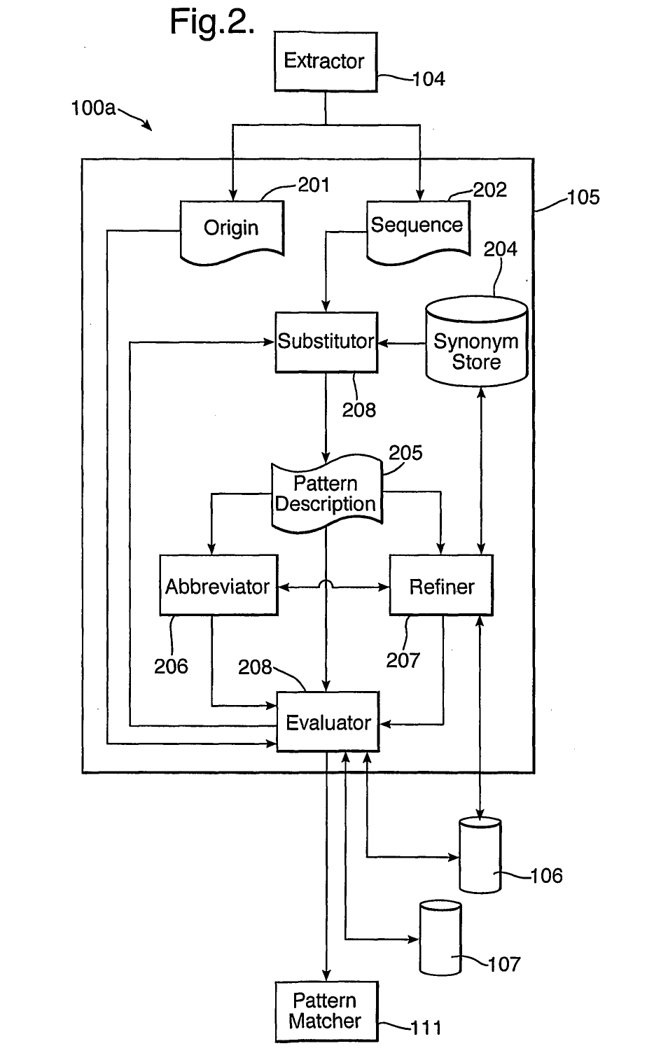

FIG. 2 is a block diagram showing in greater detail on example of pattern generator for use in the embodiment of FIG. 1.

FIGS. 1 and 2 illustrate one embodiment of the system 100 for the automated processing of emails by machine for the detection of spam. Once an email has been identified as spam, appropriate automated remedial action may be taken, though the nature of this remedial action is not material to the invention. The remedial action may include:

deleting the email; or

flagging the email as spam and/or moving it to a special folder.

The system 100 as illustrated in FIGS. 1 and 2 is intended primarily for operation by an ISP, since detection of spam on behalf of a multiplicity of users is an added-value service which the ISP can provide to them and which shares the overhead of operating the training subsystem 100a amongst the users. Further, email previously processed on their behalves is used as a resource, defining respective corpora of spam and non-spam. However, the invention is equally applicable in other contexts, for example processing emails at a gateway between a LAN and the internet and in an anti-spam filter for an email client running on a user's personal computer.

FIG. 1 shows one embodiment of the system 100 according to the present invention.

The system 100 comprises two subsystems, a training subsystem 100a and a classifying subsystem 100b.

The training subsystem 100a accepts known spam emails 101 at input 108, and known non-spam emails 102 at input 109. Patterns are passed from the pattern generator 105 to the pattern matcher 111.

The training subsystem 100a can be operated as required and is not dependent on the classifying subsystem 100b.

The classifying subsystem 100b requires the training subsystem 100a to have passed some patterns to the pattern matcher 111, otherwise the classifying subsystem 100b operates independently of the training subsystem 100a. Patterns may be passed to the pattern matcher 111 from the pattern generator 105 at any time.

The classifying subsystem 100b accepts unknown emails 103 at input 110, processes them, and signals to output 112 if the classifying subsystem 100b regards the email 103 as spam, or signals to output 113 if the classifying subsystem 100b regards the unknown email 103 as non-spam. The outputs 112 or 113 are fed to a system which takes the remedial action discussed above.

The system 100 or the classifying subsystem 100b alone, may be operated as a stand-alone system, or as part of a larger spam detection system with further evaluation performed on emails.

FIG. 2 shows the training subsystem 100a to illustrate the components contained in the pattern generator 104.

The pattern generator 104 accepts from the extractor 104 a sequence 202 and the origin 201 of the sequence 202 which specifies what component of the email 101 or 102 forms the sequence 202.

The sequence 202 is examined in a step-wise manner by the substitutor 203 which replaces in each character found in the sequence 202 with a synonym of a certain degree of specificity as defined by the synonym store 204 to produce a pattern description 205.

As will become apparent from the following description the term “synonym” is used to denote a pattern matching expression of a single character or sequence of characters. Any character may have associated with it a set of synonyms of varying degrees of specificity ranging from a pattern matching expression which matches exactly and only the single character in question through pattern matching expression of greater degrees of generality which match the character in question and others which in some sense belong to the same “class” of characters. For example, the letter “A” may be represented by a pattern matching expression which matches only that letter, one which matches it and also its lower case equivalent, “a”, one which matches alphabetic characters, printable characters and so on. Each pattern matching expression is taken from the set.

Synonyms/pattern matching expression may also be used which represent sequences of characters with varying degrees of specificity.

A particularly convenient way of implementing the pattern descriptions 205 is by the use of so-called “regular expressions”.

This pattern description 205 may be modified by the abbreviator 206 to produced a shortened form of the pattern description 205, or modified by the refiner 207 to produce a more specific pattern description 205, which itself may be passed to the abbreviator 206.

The pattern description 205 and any modified forms supplied by the abbreviator 206 and refiner 207 are passed to the evaluator 208 which, in reference to a store 106 of known spam components and a store 107 of known non-spam components determines it any of these supplied pattern descriptions 205 match the specificity criteria to be passed to the pattern matcher 111.

The training subsystem 100a operates to the following algorithm:

1) The extractor 104 extracts components of an email 101 or 102 that, when it is a spam email 101, may contain pseudo-random character data. These components may be any component where such pseudo-random data is expected to be found, for example the contents of the Message-ID header of the email 101 or 102, the contents of the MIME-Boundary header, any URLs contained within the email 101 or 102, or other features. These data, and their origin i.e. Message-ID, MIME-Boundary, URL etc. are output to the pattern generator 105 and to the store 106 of known spam components, if the extractor 104 was given a known spam email 101, or to the store 107 of known non-spam components if the extractor 104 was given a known non-spam email 102.

2) The store 106 of known spam components and the store 107 of known non-spam components record the data and origin of the data supplied by the extractor 104 for future reference.

3) The pattern generator 105 examines the output from the extractor 104.

The detailed workings of the pattern generator 105 are described below, also see FIG. 2.

Briefly, pattern descriptions 205 created by the pattern generator 105, from components supplied from the extractor 104, are tested against the components contained in the store 106 of known spam components, and the store 107 of known non-spam components. Predefined criteria determine the threshold for the minimum number of patterns matched by the pattern descriptions 205 in the store 106 of known spam components 106, and the threshold for the maximum number of patterns matched by the pattern descriptions 205 in the store 107 of known non-spam components. Pattern descriptions 205 which meet the criteria are passed to the pattern matcher 111, together with their origin 201. The pattern descriptions 205 may be passed immediately or stored to be passed later as part of a batch update.

The pattern generator 105 operates to the following algorithm:

1) The extractor 104 passes a sequence 202 of pseudo-random data and the origin 201 of the sequence 202 to the substitutor 203. The origin of the sequence 201 may be Message-ID, MIME-Boundary, URL or other pointers to where the sequence data originated.

2) The substitutor 203 refers to the synonym store 204 to create a pattern description 205 of the sequence 202 where each character within the sequence is substituted by a synonym or pattern matching expression.

The synonym store 204 holds a set of synonyms for each character which may be found within a sequence output text from the extractor 104. These synonyms are arranged in order of specificity, from least to most specific. For example, a set of synonyms for the character ‘A’ may be:

a non-white space character,

an alphanumeric character,

an upper-case letter,

the letter ‘A’.

Similarly a set of synonyms for the number ‘9’ may be:

a non-white space character,

an alpha-numeric character,

a digit,

the number ‘9’.

The substitutor 203 examines, sequentially, each character within a sequence 202. The substitutor 203 may examine characters within a sequence 202 working in any order, for example from left to right, right to left, or left to the middle character followed by right inwards to the middle character.

The substitutor 203 creates the pattern description 205, character by character in the same order that the sequence 202 is examined. Each character within the sequence 202 causes a synonym for that character to be placed in the pattern description 205. Initially the least specific synonym from the synonym store 204 for each character is chosen. For the generation of a subsequent pattern description 205, as described below, the next least specific synonym, as compared with the last pattern description generation for this sequence, is chosen for each character, thus moving from the least specific synonym to most specific synonym with each iteration.

If there no more specific synonyms available from the synonym store 204, then the pattern generator 105 exits.

3) The pattern description 205 may be passed to the abbreviator 206 to produce a shortened form of the pattern description 205. This is achieved by replacing any contiguous series of identical synonyms by a term representing ‘a series of synonyms’.

The resultant modified pattern description 205 is passed to the evaluator 208.

For example, the sequence ‘ABCD’, may, on the first pass, be described by the substitutor 203 as a pattern description comprising the synonyms:
‘a non-white space character, followed by a non-white space character, followed by a non-white space character, followed by a non-white space character’.
   The abbreviator 206 shortens this to:

‘a series of non-white space characters’.

4) The pattern description 205 may be passed to the refiner 207 to produce a more specific pattern description 205. The refiner 207 retrieves the set of sequences with the same origin as the pattern description 205 within the store 106 of known spam components.

The refiner 207 works through each character position within the sequence and compares this character with the character synonym at the corresponding position of the pattern description 205. If more than a predefined threshold number of these characters correspond to a synonym which is more specific than the synonym found at the corresponding position in the pattern description 205, as defined by reference to the synonym store 204, then the refiner 207 replaces the current synonym with the more specific synonym.

After considering each character position the resultant modified pattern description 205 may be passed to the abbreviator 206 for further modification to a shortened form by the same process as described in step 3). For example, the pattern description:
‘Upper case character, upper case character, number’, matches the set of sequences ‘AD1’, ‘BE1’, ‘CF1’ stored within the store 106 of known spam components: Examining the set of characters at the beginning of these sequences results in a set of characters ‘A’, ‘B’, ‘C’. The set of characters from the second character position is the set ‘D’, ‘E’, ‘F’. The set of characters from the end of the sequences is ‘1’, ‘1’, ‘1’. The synonym store 204 contains no more specific synonyms for the characters ‘A’, ‘B’, ‘ C’, nor for the second set, ‘D’, ‘E’, ‘F’. The pattern description currently contains the synonym ‘number’ to describe the last character position. The set of characters at this position is found to be, ‘1’, ‘1’, ‘1’, the synonym store 204 contains a more specific synonym for this set of characters than the current synonym, namely ‘the number 1’. Therefore this synonym may be substituted and the pattern description rewritten as:
‘Upper case character, upper case character, the number 1’.

5) The pattern description 205 generated by the substitutor 203 and any modified forms generated by the abbreviator 206 or refiner 207 are passed to the evaluator 208.

6) The evaluator 208 searches for sequences with the same origin as the current pattern description 205 within the store 106 of known spam components and the store 107 of known non-spam components.

The pattern description 205 is compared against these sequences and the number of sequences which can be matched by the pattern description 205 for each store is calculated.

The evaluator 208 compares these calculations with thresholds for the minimum number of matches of sequences from the store 106 of known spam components and the maximum number of matches of sequences from the store 107 of known non-spam components. If these criteria are not met, the pattern description 205 is rejected.

Otherwise, the evaluator 208 selects the most discriminating pattern description 205 from those supplied by the substitutor 203, the abbreviator 206 and the refiner 207, i.e. the pattern description 205 which matches the most sequences from the store 106 of known spam components and matches the fewest sequences from the store 107 of known non-spam components from those supplied. This pattern description 205, and its origin 201, are passed to the pattern matcher 111 for use in the classifying subsystem 100b.

The evaluator 208 returns a signal signifying its completion to the substitutor 203. The substitutor 203, continues the process at step 2 to generate a new pattern description 205 with a set of more specific synonyms, or exits if no further synonyms are available from the synonym store 204.

The classifying subsystem 100b operates to the following algorithm:

1) The extractor 114 identifies components of an email 103 that contain pseudo-random data. These components may be the contents of the Message-ID header of the email, the contents of the MIME-Boundary header, or any URLs contained within the email. These data, and their origin are output to the pattern matcher 111.

2) The pattern matcher 111 searches the sequences supplied by the extractor 114 for the presence of patterns that match any of the pattern descriptions 205 for the origin of the particular data, that have been previously supplied to pattern matcher 111 by the pattern generator 105 of the training subsystem 100a, as signified by step 115 in FIG. 2.

If such a pattern is found, the data contained within the unknown email 103 conforms to a pattern previously encountered in a number of known spam email, and to a degree that has not been substantially encountered in known non-spam email as according to the criteria applied by the evaluator 208. In such a case, the pattern matcher 111 sends a signal to the spam output 112.

If no such patterns are found, the pattern matcher send a signal to the Non-Spam output 113.

A worked example will now be given for illustrative purposes.

A known spam email 101 is fed to the training subsystem 100a.

The extractor 104 identifies the Message-ID header in the email as:
Message-ID: 12345678

The extractor 104 passes the origin 201, ‘Message-ID’, and the sequence 202, ‘12345678’ to the pattern generator.

The substitutor 203 works from left to right on the sequence.

The first character is ‘1’. The synonym store 204 returns the least specific synonym for this character as ‘non-whitespace’.

Examining each character of the sequence in turn, this generates the pattern description 205:

‘non-whitespace, non-whitespace, non-whitespace, non-whitespace, non-whitespace, non-whitespace, non-whitespace, non-whitespace’.

This pattern description 205 is passed to the abbreviator 206 which produces a modified pattern description 205 of:

‘a series of non-whitespace’.

The refiner 207 queries the store 106 of known spam components to retrieve the set of all sequences corresponding to Message-ID origin. No significant similarity can be found in the characters of the returned sequences.

The two pattern descriptions 205 are passed to the evaluator.

The evaluator 208 discovers that all the sequences corresponding to Message-ID origin in both the store 106 of known spam components and the store 107 of known non-spam components are matched by the pattern descriptions 205.

The evaluator 208 returns to the substitutor 203 without further action.

The substitutor 203 requests the next most specific synonyms for the characters in turn. This results in a pattern description 205 of:

‘digit, digit, digit, digit, digit, digit, digit, digit’.

The abbreviator 206 modifies this to:

‘a series of digits’.

The refiner 207 queries the store 106 of known spam components to retrieve the set of all sequences corresponding to Message-ID origin. In all cases in these sequences the first character is the number ‘1’.

The refiner 207 modifies the pattern description 205 to:

‘number 1, digit, digit, digit, digit, digit, digit, digit’.

These pattern descriptions 205 are passed to the evaluator 208.

The evaluator 208 discovers that both the patterns, ‘digit, digit, digit, digit, digit, digit, digit, digit’ and ‘a series of digits’, match 5% of the sequences for Message-ID held in the store 106 of all known spam components and 1% of the sequences for Message-ID held in the store 107 of all known non-spam components. The pattern description 205 ‘number 1, digit, digit, digit, digit, digit, digit, digit’, matches 5% of the sequences for Message-ID held in the store 106 of all known spam components and none of the sequences for Message-ID held in the store 107 of all known non-spam components.

All of these pattern descriptions 205 meet the criteria for passing to the pattern matcher 111. Since the pattern description 205 ‘number 1, digit, digit, digit, digit, digit, digit, digit’, has the best discrimination, it is passed to the pattern matcher 111.

The evaluator 208 returns to the substitutor 203.

An unknown email 103 is fed to the classifying subsystem 100b.

The extractor 114 identifies a Message-ID and URL within the email 103.

### The URL is:

http://www.domain.com/counter.gif?tracker_id=24543z&user_id=qs45 wt

### The Message-ID is:

Message-ID: 12470235

These sequences and their origins are passed to the pattern matcher.

The pattern matcher 111 tries to match the URL with all the pattern descriptions 205 known to it that relate to sequences with URL origin. No match is found.

The pattern matcher 111 tries to match the Message-ID sequence with all the pattern descriptions 205 known to it that relate to sequences with Message-ID origin.

The pattern description 205:

‘number 1, digit, digit, digit, digit, digit, digit, digit’ is found to match the sequence.

The unknown email 103 is classified as spam. A signal is sent to spam output 112 instructing the subsequent email processing system of the opinion of the classifying subsystem 100b.

1. An automated method of processing emails comprising:
a) defining a pattern description of a string of characters of an email, the pattern description comprising a collection of pattern matching expressions each selected from a set of such expressions which are capable of specifying with differing degrees of specificity a match with a character or with a collection of characters;
b) testing the pattern description against training sets of strings of characters extracted from emails belonging to a set of spam emails and a set of non-spam emails to determine the effectiveness of the pattern description as a classifier of individual ones of those emails into the respective sets of spam emails and non-spam emails; and
c) storing, as a reference pattern description, a pattern description determined by step b) as an effective classifier; and
d) classifying each email to be processed, using at least one reference pattern description stored in step c), into one of the respective sets of spam email and non-spam email.

2. A method according to claim 1, comprising iteratively repeating the steps a) and b) with the pattern description used in one iteration being of different generality than the one used in the previous iteration and storing as a reference description the most generalised generalized resulting description which is determined by the step b) as effective as a classifier.

3. A method according to claim 2, wherein, in said iterative repetitions of the steps a) and b), the pattern description used in one iteration is more specific than that in the previous iteration.

4. A method according to claim 2, wherein, in the initial iteration of steps a) and b), the expressions are selected to match individual characters.

5. A method according to claim 4, wherein, in subsequent iterations of steps a) and b), expressions matching individual character patterns in the string are replaced by expressions representing the pattern of a collection of character positions.

6. A method according to claim 1, wherein the step a) comprises defining a pattern description of a string of characters from at least one predetermined component of an email.

7. A method according to claim 6, wherein the at least one predetermined component comprises a message-ID.

8. A method according to claim 6, wherein the at least one predetermined component comprises a MIME-Boundary.

9. A method according to claim 6, wherein the at least one predetermined component comprises a URL.

10. A method according to claim 1, further comprising the step of:
e) selectively processing each email of step d) in accordance with its classification.

11. A method according to claim 10, wherein the step e) comprises taking remedial action in relation to emails classified as being spam.

12. A method according to claim 1, wherein the step a) of defining a pattern description of a string of characters comprises extracting a string of characters from a spam e-mail or a non-spam e-mail and generating the pattern description from the extracted string of characters.

13. A method according to claim 12, wherein the steps a) to c) are repeated by, in the step a), extracting strings of characters from plural emails.

14. A method according to claim 13, wherein the plural emails include both spam e-mails and non-spam e-mails.

15. An automated system for processing emails comprising:
a) means for defining a pattern description of a string of characters of an email, the pattern description comprising a collection of pattern matching expressions each selected from a set of such expressions which are capable of specifying with differing degrees of specificity a match with a character or with a collection of characters;
b) means for testing the pattern description against training sets of strings of characters extracted from emails belonging to a set of spam emails and a set of non-spam emails to determine the effectiveness of the pattern description as a classifier of individual ones of those emails into the respective sets of spam emails and non-spam emails;
c) means for storing, as a reference pattern description, a pattern description determined by the means b) as an effective classifier; and
d) means for classifying each email to be processed, using at least one reference pattern description stored in means c), into one of the respective sets of spam emails and non-spam emails.

16. A system according to claim 15, wherein the means a) and b) are operative iteratively with the pattern description used in one iteration being of different generality than the one used in the previous iteration and the means c) are operative to store as a reference description the most generalized resulting description which is determined by the step b) as effective as a classifier.

17. A system according to claim 16, wherein, in said iterations, the pattern description used in one iteration is more specific than that in the previous iteration.

18. A system according to claim 16, wherein, in an initial iteration, the means a) and b) are operative to select expressions which match individual characters.

19. A system according to claim 18, wherein, in subsequent iterations, the means a) and b) are operative to replace expressions matching individual character patterns in the string by expressions representing the pattern of a collection of character positions.

20. A system according to claim 15, wherein the means a) is operative to define a pattern description of a string of characters from at least one predetermined component of an email.

21. A system according to claim 20, wherein the at least one predetermined component comprises a message-ID.

22. A system according to claim 20, wherein the at least one predetermined component comprises a MIME-Boundary.

23. A system according to claim 20, wherein the at least one predetermined component comprises a URL.

24. A system according to claim 15, further comprising:
e) means for selectively processing each email classified by means d) in accordance with its classification.

25. A system according to claim 24, wherein the means e) comprises means for taking remedial action in relation to emails classified as being spam.

26. A system according to claim 15, wherein the means a) is operative to define a pattern description of a string of characters by extracting a string of characters from a spam e-mail or a non-spam e-mail and to generate the pattern description from the extracted string of characters.
